(19) United States
(12) Patent Application Publication
(10) Pub. No.: US 2019/0248986 A1
(43) Pub. Date: Aug. 15, 2019

(54) PROCESS FOR THE PREPARATION OF POLYAMIDE MATERIALS WITH IMPROVED LONG-TERM PROPERTIES

(71) Applicant: L. Brüggemann GmbH & Co. KG, Heilbronn (DE)

(72) Inventor: Klaus Bergmann, Heilbronn (DE)

(73) Assignee: L. Brüggemann GmbH & Co. KG, Heilbronn (DE)

(21) Appl. No.: 16/342,024

(22) PCT Filed: Oct. 16, 2017
(86) PCT No.: PCT/EP2017/001217

§ 371 Date: Apr. 15, 2019

(30) Foreign Application Priority Data
Oct. 17, 2016 (EP) 16002227.3

(51) Int. Cl. C08K 5/521; C08K 5/00; C08L 77/06; C08L 77/02; C08K 3/014; C08K 3/16; C08K 3/22; C08K 5/5333

(52) U.S. Cl. CPC C08K 5/521; C08K 5/005; C08L 77/06; C08K 5/0091; C08K 2003/2248; C08K 3/014; C08K 3/16; C08K 3/22; C08K 5/5333; C08L 77/02

(57) ABSTRACT

This invention concerns a process for the long-term stabilization of polyamides and the use of a specific additive composition for the long-term stabilization of polyamides.

This invention concerns a process for the long-term stabilization of polyamides and the use of a specific additive composition for the long-term stabilization of polyamides.

### BACKGROUND TO THE INVENTION

In the presence of atmospheric oxygen, thermooxidative or photooxidative reactions take place at temperatures above 70° C. or by high-energy radiation on the polyamide surface. The surface turns yellow and becomes increasingly matt and cracked. These surface changes lead to embrittlement of the material and thus to impairment of the mechanical properties of the moulded part. By adding suitable stabilizers the oxidative damage of the polyamide can be delayed, so that the time until the embrittlement of the polyamide parts can be delayed.

A distinction is usually made between stabilizers for different temperature ranges. Typical classes of stabilizers for polyamides are copper-based stabilizers and stabilizers based on sterically hindered phenols. Sterically hindered phenols are mostly used in combination with secondary antioxidants, especially phosphites. These blends of sterically hindered phenols with phosphites are referred to below as phenolic stabilizers or phenolic antioxidants. Copper-based stabilizers typically comprise at least one copper compound and at least one other halogen-containing component known as a synergist. The combination of copper compounds with halogen-containing synergists is referred to below as copper stabiliser.

So far, copper stabilizers have almost only been used in practice when high continuous operating temperatures in the range of more than 150° C. are required in the application. In addition to the topics of discoloration and lower tracking resistance, which typically occur with the use of classical copper stabilizers (copper salts in combination with halogen salts), the main reason for this is that, according to the current opinion, copper-based heat stabilizers in the temperature range below 150° C. are inferior to phenolic antioxidants with regard to stabilization against loss of mechanical characteristics.

Therefore, phenolic antioxidants are mainly used for requirements in the temperature range below 150° C. In applications that require the stabilization of polyamide materials over a very wide temperature range, copper stabilizers (for high-temperature stabilization) have so far been combined with phenolic antioxidants in practice. This leads to high stabilization costs, making polyamide materials stabilized in this way less economically attractive.

This becomes clear from the most important reference books for plastic additives, which teach experts and users that copper stabilizers above 150° C. are very effective, whereas phenolic antioxidants are more effective at temperatures below 150° C. than copper stabilizers. Examples are
“Plastics Additives Handbook” by Hans Zweifel, Ralph D. Maier and Michael Schiller (6th Edition 2009) pp. 80-84.
“Resistance and Stability of Polymers” by Gottfried Ehrenstein and Sonja Pongratz, Carl Hanser Verlag 1 Oct. 2013, Chapter 3.7.8, Page 308-313.
“Iodine Chemistry and Application”s, Tatsuo Kaiki, (1st Edition), Kapitel 31, S. 551f.
Lecture by J. R. Pauquet and A. G. Oertli (Ciba) held at the World Congress POLYAMIDE 2000, Zurich, Switzerland, 14.-16 Mar. 2000.
   The online platform “Specialchem” also reveals this conviction: http://polymeradditives.specialchem.com/selection-guide/light-stablizers-and-antioxidants-for-polyamides/heatstablizers-for-aliphatic-polyamides/

The publication “Polyamide composition stabilized with copper salt and aliphatic halogenated phosphate” DE 198476216 reveals polyamide compositions which are characterized in that at least one copper salt and at least one halogen-containing aliphatic phosphate are contained as stabilizer, whereby an increase in the continuous service temperature in the temperature range above 150° C., improved tracking resistance and lower discoloration can be achieved, immediately after injection moulding and after conditioning.

DE 198 47 626 A1 reveals a polyamide composition stabilized with copper salt and aromatic halogen compound. This teaching focuses on the stabilization of the polyamide while simultaneously raising the continuous service temperature. Heat ageing tests are indicated at temperatures of 150° C. and 165° C. The data from the tests at 150° C. do not differ in terms of measuring accuracy from the comparative data with the conventional stabilizers with salt-like halogen compounds tested there. A significant improvement of the stabilization effect is only achieved at higher temperatures, in accordance with the objective of this teaching, stabilization at elevated continuous service temperatures (165° C. or higher).

Patent specification EP 1 121 388 B1 “Polyamide compositions stabilized with copper complexes and organic halogen compounds” discloses polyamide compositions containing at least one complex of copper with at least one organic halogen compound for stabilization, whereby improved thermal stability at temperatures above 150° C., improved tracking resistance and low discoloration is achieved, immediately after injection moulding and after conditioning.

### Task of the Invention

Due to the ever-increasing field of application of plastic-based materials, e.g. in the automotive industry, better stabilization components are sought, especially for continuous service temperatures in the range of below 150° C., especially for polyamides. Typical continuous service temperatures are temperatures with a maximum temperature of around 120° C., which are frequently required in the electrical and automotive industries, for example. In this temperature range, phenol/phosphite blends are typically used as stabilizers, but these do not permit stabilization beyond a maximum time range, even if the quantity used is increased.

Therefore, the present invention has the task to indicate a way by which the desired stabilization can be achieved at rather low to medium continuous service temperatures, i.e. in particular to enable polyamide compositions which exhibit improved long-term stabilization against heat over a wide range (also at high temperatures above 150° C. and up to 180° C.), and at the same time are stabilized particularly efficiently at temperatures below 150° C. with respect to a significant extension of the possible service life, preferably both:
a) in terms of maintenance of tensile strength and impact strength (prevention of embrittlement);
b) in terms of very good retention of elongation at break and at the same time a good retention of tensile strength and impact strength.

### SHORT DESCRIPTION OF THE INVENTION

This task is solved by claims 1 and 2. Preferred configurations are indicated in the subclaims as well as in the following description.

### SHORT DESCRIPTION OF THE FIGURE

FIG. 1 shows the half-lives of elongation at break for various examples and comparison examples under heat storage at 120° C.

### DETAILED DESCRIPTION OF THE INVENTION

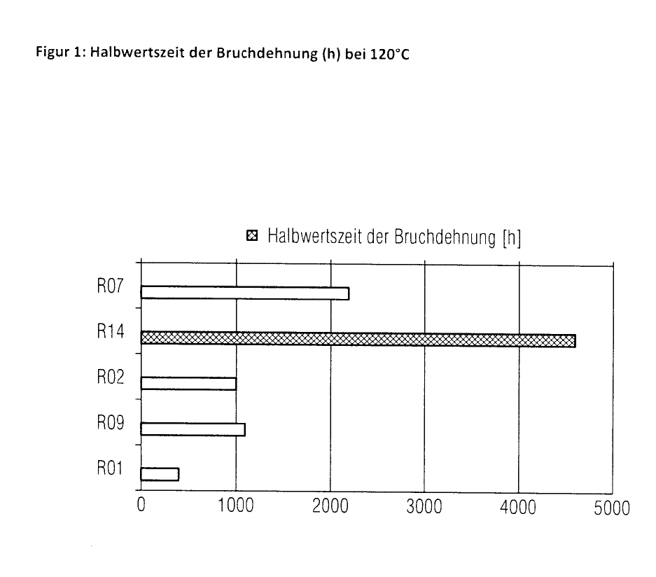

The invention at hand surprisingly enables the desired stabilization of polyamides by the use of already known components, which up to now were known exclusively for high-temperature stabilization in the state of the art. Nevertheless, significantly improved stabilization can be achieved at continuous service temperatures of 150° C. or lower, such as 120° C., especially compared to the compounds previously used to stabilize polyamides at lower continuous service temperatures. The stabilizers to be used according to the invention are well dispersible in polyamides, so that they are easy to handle. The stabilizers according to the invention can be introduced into polyamides by conventional methods and distributed therein. In addition, the stabilizer components can be easily compounded for use, for example by compounding with a matrix of common materials such as waxes or polymers. This invention therefore allows the realization of the following advantages:
1. Improvement of stabilization of unreinforced and reinforced polyamides against prolonged exposure at temperatures below 150° C. Delaying degradation for as long as possible and thus reducing the service properties, in particular maintaining the mechanical properties of tensile strength and impact strength for as long as possible.
2. The elongation at break generally drops particularly quickly and significantly with heat aging. A particularly important advantage for the practical application of polyamide materials is therefore the invention-based possibility of significantly prolonging the maintaining of the elongation at break during long-term storage under temperature stress (at temperatures below 150° C.) compared to phenolic antioxidants. A high elongation at break of the polymer matrix (also in reinforced polyamides) leads to a significant improvement in the application properties of the entire material and to an increase in the energy absorption capacity.
3. The amount of stabilizer used can be adapted to the desired stabilization time (product life), since the stabilizers to be used according to the invention allow an extension of the stabilizing properties when the amount used is increased, an effect which is not so pronounced especially with phenolic stabilizers. These stabilizers do not show any extension of the stabilization effect very quickly, even with a significant increase in the quantity used. On the contrary, at high dosages (e.g. in the range above 1%) there may even be a deterioration of the stabilizing effect. FIG. 1 shows the half-life of the elongation at break (determined at 120° C.) of polyamide 6.6 using different stabilizers. Sample R01 is unstabilized polyamide, samples R02 and R09 are polyamides stabilized with phenolic stabilizers (identical polyamide 6.6 was used in all samples), whereby the amount of phenolic antioxidant used in sample R09 was doubled compared to R02. However, this has hardly any effect on the half life of the elongation at break. Sample R07 is a stabilized sample according to the invention (amount of stabilizer is equivalent to the amount in sample R02). Here the dramatic and surprising increase of the half-life to be achieved (i.e. the time that elapses until the original value of the elongation at break has dropped to half) compared to phenolic stabilizers is already evident. For sample R014, the used quantity was again doubled (compared to R07)—this shows a very clear further extension of the half-life. This effect can also be clearly seen in the samples R06 and R13 (twice the amount of additive compared to R06) stabilized according to the invention. This enormous stabilization efficiency of the inventive process can also be used to use small amounts of stabilizer to ensure the level of continuous use times that can be achieved with phenolic stabilizers. This results in cost advantages, advantages in terms of freedom from labelling and the possibility of getting by with low halogen contents, so that use is also facilitated in difficult electrical and electronic applications.
4. Due to the improved stabilization, components may be thinner, since a material thickness previously regarded as necessary (due to a desired redundancy or a corresponding safety factor) can be reduced (since the polyamides stabilized according to the invention can withstand longer loads even with lower material thicknesses).
5. According to the invention, the following advantages can also be realized:
   Long delay of degradation and associated reduction of service properties, in particular prolonged maintenance of mechanical properties such as tensile strength, elongation at break and impact strength;
   Efficient stabilisation of polyamides (and prevention of embrittlement) over a very wide temperature range, even at temperature peaks of up to 200° C. (e.g. for materials which have to withstand a rather low continuous service temperature, whereby temperature peaks may occur during the life cycle), without any impairment of material quality having to be expected (since the effectiveness of the combination of copper component and synergist to be used in accordance with the invention is known at high temperatures). Phenolic stabilizers alone are not suitable for such applications as they cannot prevent rapid degradation of essential properties at high temperatures (>150° C.). For such application requirements with different temperature loads, it is no longer necessary to use different stabilizer systems for the different temperature ranges (e.g. a combination of both phenolic stabilizers and copper-based stabilizers) due to the invention-based stabilization processes;
   Colour neutrality or only slight discolouration after conditioning;
   No or at least only an acceptable influence on the tracking resistance, which is very important for use in the electrical and electronics industry.

Surprisingly, therefore, improved stabilization can be achieved by using methods in which polyamides are stabilized with copper compounds which are suitably combined with a synergistically acting halogen-containing aliphatic phosphate. Polyamide compositions provided with this stabilizer combination exhibit better stabilization at temperatures below 150° C., preferably at temperatures of 145° C. or less, such as 140° C. or less, 130° C. or less, such as 125° C. or less, in particular 120° C. or less, compared to conventional copper-based and/or organic stabilizers (phenolic antioxidant combinations alone and with phosphites). In particular, the tensile strength and impact strength of these polyamide compositions at temperatures below 150° C. are maintained at a high level for much longer.

In addition, it was surprisingly found that the combination of complexes of copper with halogenated aliphatic phosphate in particular allows the elongation at break after heat aging to be kept at a high level for a much longer time compared to the previously known stabiliser systems for polyamides, also compared to combinations of copper salts or other copper compounds (which are not copper complexes) with halogenated phosphate or with other halogen compounds including halogen salts. This effect occurs especially at temperatures below 150° C. At higher temperatures, e.g. at 180° C., there are no differences with regard to maintaining elongation at break compared to stabilization with conventional copper stabilizers.

Altogether, therefore, the stabilizer combinations to be used according to the invention can achieve long-term stabilization over an extremely wide temperature range with a single stabilizing component (the combination to be used according to the invention). The following explanations and examples show that in addition to the surprising stabilization discussed above at temperatures below 150° C. with the combination to be used according to the invention, stabilization at a temperature range of significantly above 150° C., such as from above 180° C. to about 200° C., is also possible. In the state of the art, combinations of different stabilizers are considered necessary for such stabilizations over such a wide temperature range. Typically, for stabilization at low temperatures, the use of the phenolic compounds described is considered essential, but at temperatures above 150° C., they no longer have any de facto effect. Therefore, in the state of the art, if stabilization is desired for a temperature range from 120° C. to 180° C., for example, a combination of phenolic antioxidants with other copper-based stabilizers for a temperature range above 150° C., for example, must be used. Such combinations will no longer be necessary in accordance with the findings of the present invention, as the special stabilizer combinations of the present invention can safely cover the whole temperature range.

Thus, in addition to the method and use indicated for long-term stabilization at temperatures below 150° C., the present invention provides a system capable of safely stabilizing polyamides over a wide temperature range, said temperature range comprising temperatures below 150° C. and also temperatures of 150° C. or more. The temperature range of 150° C. or higher extends in particular to over 160° C. or higher, including 180° C. or higher, and usually up to 200° C. The present invention thus makes it possible to replace the combinations of several different stabilisation systems considered necessary in the state of the art by a single system, as described here. Stabilized polyamide compositions of this aspect of the present invention therefore preferably comprise as stabilizer only the temperature stabilization system described here. This simplifies both the compounding process and enables cost savings, as the phenolic systems in particular can be dispensed with. For this purpose, as the following experimental data in particular demonstrate, an overall improved system will be made available, so that significant extensions of the stabilization periods can also be realized.

If stabilization is desired in an even wider temperature range, i.e. especially at temperatures above 200° C., known high-temperature stabilizers for polyamides can be used. In particular, polyols with 2 or more hydroxyl groups can be used for this purpose. Well-known examples of such compounds are polyols with 2 to 12 hydroxyl groups and a molecular weight of 64 to 2000 g/mol. Especially suitable examples are pentaerythritol, dipentaerythritol and tri pentaerythritol, especially di pentaerythritol. Such compounds can be introduced into the polyamide in a conventional way. Especially suitable is the introduction via a premix, preferably via a masterbatch, whereby the premix or masterbatch also contains the other stabilizing components in accordance with the present invention. The application quantities of such further high-temperature stabilizers can be selected by a specialist on the basis of already known information or determined by simple tests for a desired polyamide composition.

With the polyamide compositions stabilized based on copper complexes and halogenated aliphatic phosphates according to invention, a very good colour and high tracking resistance are achieved at the same time. This also allows the use in areas which require a high tracking resistance in the form of a CTI value (comparative tracking index) of 600 V (for non-reinforced polyamides).

What is surprising in connection with the present invention is that by combining a copper component with a specific synergist, as defined in claims 1 and 2, an unexpected improvement in the stabilization of polyamides can be achieved which surpasses both the classical phenolic stabilizers and cannot be achieved with other combinations of known copper stabilizers and halogen-containing synergists. This is particularly demonstrated in the following examples, where conventional copper-based systems (copper salt and halogen salt or copper complex and halogen-containing organic compound (no aliphatic phosphate)) do not allow the effects to be achieved with the combination according to the invention.

The copper stabilizers to be used according to the invention consist of two essential components, namely a mixture of copper compounds and special halogen-containing compounds (here also referred to as synergists). The copper compound used according to the invention can be any copper salt (CuI, CuBr, copper acetate, CuCN, copper stearate, . . . ) or any other copper compound such as CuO, Cu2O, copper carbonate or any complex of copper. The synergist to be used according to the invention is a halogen-containing aliphatic phosphate.

These two components are typically used in quantities to give a Cu:halogen ratio of 1:1 to 1:50 (molar ratio), preferably 1:4 to 1:20, more preferably 1:6 to 1:15.

The amounts of copper and halogen in the polyamide are selected depending on the desired use of the polyamide and the desired stabilization. The amount of copper used is not limited as long as the mechanical properties of the polyamide are not adversely affected. The application quantities of copper are usually in the range of 1 to 1000 ppm Cu, preferably 3 to 200 ppm Cu, more preferably 5 to 150 ppm Cu. Concrete examples are 33 ppm, 66 ppm and 100 ppm. The quantities of synergist used (in each case based on ppm halogen) thus result from the above-mentioned ratios. The amount of synergist to be added is not subject to any particular restriction. However, additions of more than 1% generally do not improve the stabilizer effect. Typical application quantities are in the range of 10 to 10,000 ppm. Preferred quantities are in the range of 30 to 2000 ppm, more preferably 50 to 1500 ppm.

According to the invention, all common polyamides can be stabilized. Polyamides are polymers with recurring carbonamide groups —CO—NH— in the main chain. They are formed of
(a) aminocarboxylic acids or their functional derivatives, e.g. lactams; or from
(b) diamines and dicarboxylic acids or their functional derivatives.

By varying the monomer building blocks, polyamides are available in a wide variety. The most important representatives are polyamide 6 from c caprolactam, polyamide 6.6 from hexamethylene diamine and adipic acid, polyamide 6.10 and 6.12, polyamide 11, polyamide 12, PACM-12 as well as polyamide 6-3-T, PA4.6 and semi-aromatic polyamides (polyphthalamide PPA).

However, according to the invention, all other polyamides can also be stabilized, for example copolyamides or copolymers of polyamides with other segments, for example with polyesters. It is also possible to stabilize blends of different polyamides and blends of polyamides with other polymers. Polyamide 6 and polyamide 6.6 are particularly preferred.

The stabilizer blends according to the invention can be used in all previously mentioned polyamides and blends, both in unfilled and non-reinforced polyamides as well as in filled and reinforced polyamides. As fillers/reinforcing materials glass fibres, carbon fibres, glass balls, diatomaceous earth, fine-grained minerals, talcum, kaolin, phyllosilicates, CaF2, CaCO3 and aluminium oxides can be used.

Copper complexes to be used according to the invention are complexes of copper with ligands such as triphenylphosphines, mercaptobenzimidazoles, glycine, oxalates and pyridines. Chelate ligands such as ethylenediaminetetraacetates, acetylacetonates, ethylenediamines, diethylenetriamines, triethylentetraamines, phopsphinchelate ligands or bipyridines can also be used. Examples of the preferred phosphine chelate ligands are 1,2-bis-(dimethylphosphino)-ethane, bis-(2-diphenylphosphinoethyl)-phenylphosphine, 1,6-(bis-(diphenylphosphino))-hexane, 1,5-bis-(diphenylphosphino)-pentane, Bis-(diphenylphosphino)methane, 1,2-bis-(diphenylphosphino)ethane, 1,3-bis-(diphenylphosphino)propane, 1,4-bis-(diphenylphosphino)butane and 2,2′-bis-(diphenylphosphino)-1,1′-binaphthyl.

These ligands can be used individually or in combination to form complexes. The syntheses required for this are known to the expert or described in the specialist literature on complex chemistry. As usual, these complexes may also contain typical inorganic ligands, such as water, chloride, cyano ligands, etc., in addition to the ligands mentioned above.

Copper complexes with the complex ligands triphenylphosphines, mercaptobenzimidazoles, acetylacetonates and oxalates are preferred. Triphenylphosphines and mercaptobenzimidazoles are particularly preferred.

Preferred copper complexes used according to the invention are usually formed by reaction of copper(I) ions with the phosphine or mercaptobenzimidazole compounds. For example, these complexes can be obtained by reacting triphenylphosphine with a copper(I) halide suspended in chloroform (G. Kosta, E. Reisenhofer and L. Stafani, J. lnorg. Nukl. Chem. 27 (1965) 2581). However, it is also possible to reductively react copper(II) compounds with triphenylphosphine to obtain the copper(I) addition compounds (F. U. Jardine, L. Rule, A. G. Vohrei, J. Chem. Soc. (A) 238-241 (1970)).

However, the complexes used according to the invention can also be produced by any other suitable process. Suitable copper compounds for the preparation of these complexes are the copper(I) or copper(II) salts of the hydrogen halide acids, the hydrocyanic acid or the copper salts of the aliphatic carboxylic acids. Examples of suitable copper salts are copper (I) chloride, copper (I) bromide, copper (I) iodide, copper (I) cyanide, copper (II) chloride, copper (II) acetate or copper (II) stearate.

Copper(I)iodide and copper(I)cyanide are particularly preferred.

In principle, all alkyl or aryl phosphines are suitable. Examples of phosphines which can be used according to the invention are triphenylphosphine (TPP), substituted triphenylphosphines, trialkylphosphines and diarylphosphines. An example of a suitable trialkylphosphine is tris-(n-butyl)phosphine. In general, triphenylphosphine complexes are more stable than trialkylphosphine complexes. Triphenylphosphine is also economically preferred due to its commercial availability.

Examples of suitable complexes can be represented by the following formulae: [Cu(PPh₃)_{3X}], [Cu₂X₂(PPh₃)₃], [Cu(PPh₃)X]₄ and [Cu(PPh₃)₂X], wherein X is selected from CI, Br, I, CN, SCN or 2-MBI.

However, complexes that can be used according to the invention may also contain additional complex ligands. Examples are bipyridyl (e.g. CuX (PPh₃) (bipy) where X is Cl, Br or I), bichinoline (e.g. CuX (PPh₃) (biquin) where X is Cl, Br or I) and 1,10-phenanthroline, o-phenylenebis(dimethylarsine), 1,2-bis(diphenylphosphino)ethane and terpyridyl.

These complexes are generally non-conductive and diamagnetic. They are usually colourless and accumulate as water-insoluble crystals which melt undecomposed. The complexes are easily soluble in polar organic solvents such as DMF, chloroform and hot ethanol.

The copper salt to be used according to the invention can be any copper salt.

Salts of monovalent or divalent copper with inorganic or organic acids are preferred.
Examples of suitable copper salts are the copper(I) salts, such as CuI, CuBr, CuCl or CuCN, Kupfer(II) salts, such as CuCl₂, CuBr₂, CuI₂, copper acetate, copper sulphate, copper stearate, copper propionate, copper butyrate, copper lactate, copper benzoate or copper nitrate, as well as the ammonium complexes of the salts mentioned above.

Compounds such as copper acetylacetonate or copper EDTA can also be used. It is also possible to use mixtures of different copper salts. If necessary, copper powder can also be used.

Preferred are the copper(I)halides and the copper salts of organic acids. Copper(I)iodide and copper acetate are particularly preferred.
The aforementioned copper components can be used individually or in mixtures of two or more components.

The synergist to be used according to the invention is a halogen-containing aliphatic phosphate.

According to the invention, at least one halogen-containing aliphatic phosphate is used, preferably in the form of a tris(halohydrocarbyl)-phosphate or a phosphonate ester. Tris(bromohydrocarbyl) phosphates (brominated aliphatic phosphates) are preferred. In particular, in these compounds no hydrogen atoms are attached to an alkyl C atom which is in the alpha position to a C atom attached to a halogen. This means that no dehydrohalogenation reactions can occur. Example compounds are tris(3-bromo-2,2 bis(bromomethyl)propyl)phosphate, tris(dibromoneopentyl)phosphate, tris(trichloroneopentyl)phosphate, tris(chlorodibromoneopentyl)phosphate and tris(bromodichloroneopentyl)phosphate. Preferred are Tris-(dibromoneopentyl)phosphate and Tris (tribromoneopentyl)phosphate.

It is also possible to use mixtures of several halogen-containing aliphatic phosphates. Furthermore, mixtures of halogen-containing aliphatic phosphates with aromatic halogenated compounds, e.g. brominated polystyrenes or poly(pentabromobenzyl)acrylates, can also be used. Tris(haloaromatic)phosphates or phosphonate esters may also be used as aromatic halogenated compounds, e.g. tris(2,4-dibromophenyl)phosphate, tris(2,4-dichlorophenyl)phosphate and tris(2,4,6-tribromophenyl)phosphate. However, it is preferable to use only halogenated aliphatic phosphates as synergists.

Preferred combinations (hereinafter referred to as stabilizer blends) are combinations of copper salt, especially CuI, and the phosphates described here, especially brominated phosphates, as well as combinations of copper complexes, especially complexes with TPP ligands and the phosphates described here, especially brominated phosphates.

Polyamide and stabilizer blend are either melted together and mixed, or the polyamide is melted first and then the stabilizer blend is mixed in, the latter being preferred. In a preferred design, the stabilizer blend is added to the molten polyamide in the form of a premix (concentrate or masterbatch).
The specialist is familiar with suitable mixing equipment and includes mixing mills, discontinuously operating internal mixers and kneaders, continuously operating extruders and kneaders as well as static mixers. Preference is given to the use of continuously operating extruders, both single-screw and twin-screw extruders, which enable good mixing. Usually, the polyamide is first melted in the extruder and the stabilizer blend is then metered in through suitable openings (gravimetric or volumetric). These procedures as well as the necessary devices are known to the specialist.
However, it is also possible to add the stabilizing components during the production of the polyamide, i.e. the monomer mixture. This allows very good mixing without additional mixing, which reduces production costs and times.
If a pre-concentrate of the stabilizer blend is used, this pre-concentrate can be produced in discontinuously operating mixers which enable very good, homogeneous distribution, for example in a Buss Kneader. Usually, however, continuous mixers are used, such as twin-screw extruders or ZSK extruders. The same polyamide is usually used as the matrix material, which is then mixed with the pre-concentrate. However, it is also possible to choose a different polyamide or polymer. Optionally, additional additives can be added during masterbatch production.
Alternatively, a pre-concentrate can be produced in another preferred version by mixing the stabilizer blend together with other additives and/or additives, e.g. lubricant, demoulding agent, nucleating agent etc. and subsequently agglomerating or pelletizing, compacting or tabletting. The relevant procedures as well as the necessary devices are known to the specialist.
However, the additives and/or further components mentioned can also be used separately in the process according to the invention, for example by a separate dosing during the production of stabilized polyamides according to the invention.

Another positive effect of the present invention concerns the aspects of occupational safety, environmental protection and applicability in electrical and electronic applications (despite the content of halogen-containing compounds). Classical copper stabilizers as well as halogen-containing materials are subject to special regulations with regard to labelling, transport, storage and handling in accordance with CLP Regulation No. 1272/2008.

A critical issue in the use of halogenated materials is corrosion, especially electrocorrosion. In this context, halogens, especially bromine and chlorine, but also iodine, are considered harmful for electrical components due to interactions of halide anions with intermetallic phases. Therefore, a demand for a reduction in the halogen content is now widespread in the electrical and electronics industries. According to international standards IEC 61249-2-21 and EN 61249-2-21 and IPC 4101 for PCB materials (printed circuit boards), materials containing less than 1500 ppm of CI and Br with a maximum quantity of Br and Cl of 900 ppm each are considered halogen-free. Due to its extremely good effectiveness, the stabilizer combination to be used according to the invention can be used in low doses so that corresponding limit values can be adhered to. It is also possible to keep the concentrations of copper and halogens low during the production of the stabilizer combinations, for example by producing the pre-concentrates described above. In this way, low concentrated additives (related to the inventive stabilizer combinations) become accessible, with the advantages already described above. Overall, this also simplifies the handling of the stabilizer components to be used according to the invention for the user, as no labelling is required according to GHS/CLP Regulation (EC) No. 1272/2008. This leads to reduced costs for storage and transport, among other things.
Such materials also present fewer risks with regard to environmental hazards and occupational safety.
The following examples explain the invention.

### EXAMPLES

In all examples, polyamide was compounded with the stabilizers mentioned in a conventional way and the mechanical and other properties to be tested were evaluated on test specimens. The ageing conditions are indicated in each case.

A polyamide 6.6 from BASF was used (Ultramid A27 E).
Componenting was carried out with a twin-screw extruder from Leistritz ZSE27MAXX-48D.
The additives were added gravimetrically during compounding.
After drying, “Demag Ergotech 60/370-120 concept” standard test rods for determining the mechanical properties (ISO 527) and impact strength (ISO 179/1 eU) were produced from the compound on a Demag Ergotech 60/370-120 concept injection moulding machine.
In convection ovens, the test rods were stored at the temperatures given in the examples (120° C., 140° C., 150° C. and 180° C.).
Elastic modulus [MPa], tensile strength [MPa] (elongation [%]) and fracture stress [MPa] (elongation [%]) were measured in a tensile test according to ISO 527 using a Zwick Z010 static materials testing machine.
The impact strength was measured in accordance with ISO 179/1 eU in the Charpy impact bending test using a pendulum impact tester HIT PSW 5.5J.

Chemical compounds and abbreviations used:

TPP: triphenylphosphine; P(C₆H₅)₃
PDBS: polydibromostyrene; [CH₂—CH(C₆H₃Br₂)-]ₙ
Phosphate 1: Tris-(Tribromoneopentyl)-phosphate; C₁₅Br₉H₂₄O₄P
Phenol/Phosphite Blend B1171: 1.1 Mixture of tris-(2,4-di-tert.butylphenyl)phosphite and N,N′-hexane-1,6-diylbis(3-(3,5-di-tert.-butyl-4-hydroxyphenylpropionamide))

TABLE 1
Stabilization of polyamide 6.6 natural; heat ageing at 120° C.

| | | | | half-life period | Time until impact |
|---|---|---|---|---|---|
| | | | Time to reach 90% | the elongation | strength falls |
| Number | type | Composition | of tensile strength | at break | below 10 kJ/m2 |
| R01 | | Without stabilizer | 180 h | 400 h | <500 h |
| R02 | comparative | 0.5% B1171 (Phenol/ | 1.500 h | 1.000 h | 2.400 h |
| | | Phosphite Blend) | | | |
| R03 | comparative | CuI/KI | 2.200 h | 1.300 h | 3.400 h |
| R04 | comparative | CuI(TPP)₃/PDBS | 1.200 h | 1.300 h | <2.000 h |
| | | (aromatic | | | |
| | | halogen compound) | | | |
| R05 | invention | CuI/Phosphate 1 | 4.300 h | 1.500 h | 4.800 h |
| R06 | invention | CuI(TPP)/Phosphate 1 | >5.000 h | 2.500 h | 4.700 h |
| | | | (97% after 5.000 h) | | |
| R07 | invention | CuI(TPP)₂/Phosphate 1 | >5.000 h | 2.200 h | 4.500 h |
| | | | (92% after 5.000 h) | | |

Comparative tests with phenolic antioxidants and other copper stabilizers (inventive combinations and comparison variants); measurement of tensile strength, elongation at break and impact strength on the corresponding test specimens.
With the copper stabilizers a Cu concentration of 33 ppm and a halogen concentration of 400 ppm was used.
The time was determined until the impact strength fell to the absolute value of 10 kJ/m2. Furthermore, the time was determined until the tensile strength drops to the 90% value of the initial strength and until the elongation at break reaches half of the initial value (half value measurement).

TABLE 2
Stabilization of polyamide 6.6 natural; heat ageing at 120° C.

| | | | Time to reach 70% | half-life of |
|---|---|---|---|---|
| | | | of initial tensile | elongation at |
| array | type | Composition | strength | break |
| R08 | | Without stabilizer | 500 h | 400 h |
| R09 | comparative | 1% B1171 | 2.100 h | 1.100 h |
| | | (phenol/phosphite blend) | | |
| R10 | comparative | CuI/KI | 6.200 h | 3.300 h |
| R11 | comparative | CuI(TPP)3/PDBS | 5.900 h | 1.000 h |
| R12 | comparative | CuI(TPP)/PDBS | 5.800 h | 1.300 h |
| R13 | invention | CuI(TPP)/Phosphate 1 | 9.200 h | 4.700 h |
| R14 | invention | CuI(TPP)2/Phosphate 1 | 9.800 h | 4.600 h |

Comparative tests with phenolic antioxidants and copper stabilizers (inventive combinations and comparison variants);

measurement of tensile strength and elongation at break on the corresponding test specimens.

With the copper stabilizers a Cu concentration of 66 ppm and a halogen concentration of 800 ppm was used.
The time until the tensile strength drops to the 70% value of the initial strength and the time until the elongation at break reaches half of the initial value (half value measurement) was determined.

TABLE 3
Stabilization of polyamide 6.6 natural; heat ageing at 180° C.

| | | half-life of | half-life of | |
|---|---|---|---|---|
| | | tensile | elongation | Half-life of the |
| type | Composition | strength | at break | impact strength |
| | Without stabilizer | 60 h | 24 h | 24 h |
| comparative | CuI/KI | 650 h | 250 h | 240 h |
| invention | CuI/Phosphate 1 | 720 h | 240 h | 240 h |
| invention | CuI(TPP)2/ | 700 h | 240 h | 230 h |
| | Phosphate 1 | | | |

Comparative tests with copper stabilizers (inventive combinations and comparative variant);

measurement of tensile strength, elongation at break and impact strength on the corresponding test specimens.

With the copper stabilizers a Cu concentration of 100 ppm and a halogen concentration of 1200 ppm was used.
The times were determined until impact strength, tensile strength and elongation at break reach half of the respective initial value (half-value measurements).

TABLE 4
Colour and tracking resistance of polyamide 6.6

| | | | | Classification of the used |
|---|---|---|---|---|
| | | | tracking | stabiliser blend* on the basis of |
| | | Colour after | resistance | Regulation (EC) No 1272/2008 |
| type | Composition | conditioning | CTI value [V] | [CLP Regulation]. |
| | Without stabilizer | colourless | 600 | — |
| comparative | 0.5% B1171 | colourless | 600 | not classified* |
| | (Phenol/Phosphite | | | |
| | Blend) | | | |
| comparative | CuI/KI | light green | 450 | *GHS05, GHS07, GHS08, |
| | | | | GHS09 |
| invention | CuI/Phosphate 1 | blue-green | 550 | not classified* |
| invention | CuI(TPP)/Phosphate 1 | Slightly bluish | 600 | not classified* |
| invention | CuI(TPP)2/Phosphate 1 | colourless | 600 | not classified* |

*applies to typical formulations of stabilizer blends, which are adjusted in such a way that the amount added is in the range of 0.5 to 3% stabilizer (based on the polyamide content).

Comparison tests with phenolic antioxidants and other copper stabilizers (inventive combinations and comparison variants);

addition of 100 ppm Cu/1000 ppm halogen for copper stabilizers.

Test plates of 3×5 cm and 3 mm thickness were produced on the injection moulding machine from the granulates described above and the CTI values were measured in accordance with the IEC-60112 standard. The discoloration of the test plates was visually assessed.

Tables 1 to 4 summarize different tests and comparative tests. These impressively demonstrate the advantages associated with this invention. Table 1 shows, for example, that the stabilizer components used according to the invention can maintain the mechanical property profile of the stabilized polyamide in a very good range over much longer periods of time, compared with standard phenolic stabilizers, but also compared with known copper-based systems. Although the stabilizer systems copper iodide/potassium iodide as well as copper complex and aromatic halogen compounds show stabilizing effects comparable to those of phenolic stabilizers, the high level of polyamides stabilized according to the invention cannot be achieved.

Table 2 summarizes corresponding experiments, but with increased stabilizer quantities. This shows that an increase in the amount of phenolic stabilizer only leads to minor improvements compared to lower contents. A plateau is reached here, so that even further increases in the input quantity do not lead to any further improvements. In contrast, the stabilizer combinations of the present invention show a clear extension of the stabilization effect.

Table 3 summarizes heat ageing tests at high temperatures. This shows that both invention-based combinations and conventional copper-based systems (here copper iodide/potassium iodide) show approximately the same stabilizing effects, which can again be taken as evidence that the improved stabilizing effect at low temperatures is to be regarded as surprising for the invention-based combinations, since at the higher temperatures typical for these stabilizers, there is no significant difference in the stabilizing effect.

Table 4 lists tests and comparative tests which show the suitability of the respective stabilizers for the stabilization of polyamides to be used in the electrical/electronics sector. The CTI value is particularly relevant here, since in many areas stabilised polyamides are only used if the CTI value is 600 V, or at least not very far below 600 V. Here it is shown that the invented stabilizer combinations fulfil this requirement, in particular the invented stabilizer combinations which do not contain salt-based components. In contrast, classic, salt-based copper stabilizers are not suitable for these applications.

These tests and comparative trials show once again that the polyamides stabilized in accordance with the invention have excellent property profiles. With the stabilizer components to be used according to the invention, properties can be specifically controlled over a wide range of a matrix of properties. On the one hand, it is possible to adjust the mechanical stability of the polyamide to be stabilized over a wide range, which is far higher than what can be achieved with conventional phenolic stabilizers in the low to medium temperature range, even with small quantities used. At the same time, stabilized polyamides can also be obtained which have a high tracking resistance (high CTI values) and show no or only a low tendency to discoloration after conditioning. This again confirms the outstanding property profile of the stabilizer combination to be used in accordance with the invention.

In order to demonstrate the surprising efficacy of the stabilizers to be used according to the invention, especially in comparison with the known phenolic stabilizers, the half-lives of elongation at break for compositions with PA 6.6 were evaluated for different combinations.

TABLE 5
Half-life [h] of the elongation at break of
polyamide 6.6 as a function of stabilization.

| | Ageing temperature [° C.] | | | |
|---|---|---|---|---|
| | 120° C. | 140° C. | 150° C. | 180° C. |
| Without stabilizer | 400 h | 100 h | 50 h | 24 h |
| 0.5% B1171 | 1000 h | 320 h | 200 h | 30 h |
| (Phenol/Phosphite | | | | |
| Blend) | | | | |
| CuI(TPP)2/ | 2200 h | 900 h | 600 h | 220 h |
| Phosphate1 (33 ppm | | | | |
| Cu, 400 ppm Halogen) | | | | |
| CuI/Phosphate 1 | 1500 h | 800 h | 550 h | 210 h |
| (33 ppm Cu, 400 ppm | | | | |
| Halogen) | | | | |
| CuI(TPP)2/ | 4600 h | 1600 h | 900 h | 230 h |
| Phosphate1 (66 ppm | | | | |
| Cu, 800 ppm Halogen) | | | | |
| CuI/Phosphate 1 | 3900 h | 1350 h | 800 h | 230 h |
| (66 ppm Cu, 800 ppm | | | | |
| Halogen) | | | | |

Comparison tests with phenolic antioxidants and copper stabilizers (inventive combinations);

measurement of elongation at break on the corresponding test specimens.

The time was determined until the elongation at break reaches half of the initial value (half-value measurement).
The data in the above table show that better (longer) preservation of elongation at break is achieved in polyamide 6.6, especially at 120° C. and 140° C., with the inventive variants compared to a classic phenol/phosphite based system (B1171). At the same time, it becomes clear that the inventive use also offers protection against temperature peaks above 150° C., temperature ranges in which stabilizers based on phenol/phosphite have only a very minor effect. This applies in particular to temperatures in the range of 170° C. and higher, at which the effectiveness of these stabilizers is no longer given. Due to the high effectiveness of the stabilizers according to the invention, even with low copper and halogen concentrations in the polyamide, very good long-term service properties of the respective materials can be achieved over a wide temperature range. Due to the low concentrations required for this, bright colors, good electrical properties, low stabilization costs and a significantly reduced tendency to electrocorrosion, among other things, can be achieved.

1. Process for stabilizing polyamides at temperatures of less than 150° C., characterized in that a polyamide is mixed with a copper compound and a halogen-containing aliphatic phosphate.

2. Use of a composition comprising a copper compound and a halogen-containing aliphatic phosphate for stabilizing polyamides at temperatures of less than 150° C.

3. Process according to claim 1 or use according to claim 2, characterized in that the stabilization of polyamides takes place at temperatures of 145° C. or less, in particular at temperatures of 130° C. or less.

4. A process according to claim 1 or 3 or use according to claim 2 or 3, characterized in that the copper compound is a copper(I) salt, a copper(II) salt or a copper complex.

5. A method or use according to claim 4, characterized in that the copper(I) salt is selected from CuI, CuBr, CuCl, CuCN, Cu2O or mixtures thereof.

6. A method or use according to claim 4, characterized in that the copper(II) salt is selected from copper acetate, copper stearate, copper sulfate, copper propionate, copper butyrate, copper lactate, copper benzoate, copper nitrate, CuO, CuCl₂ or mixtures thereof.

7. A method or use according to claim 4, characterized in that the copper complex is selected from copper acetylacetonate, copper oxalate, copper EDTA, Cu(PPh₃)₃X], [Cu₂X₂(PPH₃)₃], [Cu(PPh₃)X], [Cu(PPh₃)₂X], [CuX(PPh₃)(bipy)], [CuX(PPh₃)(biquin)] wherein X═Cl, Br, I, CN, SCN or 2-mercaptobenzimidazole.

8. A method or use according to any of claims 1 to 7, characterized in that the halogen-containing aliphatic phosphate is a tris(halohydrocarbyl)phosphate or a phosphonate ester.

9. A method or use according to claim 8, characterized in that the tris(halohydrocarbyl)phosphate is selected from tris(3-bromo-2,2-bis(bromomethyl)propyl)phosphate, tris(dibromoneopentyl)phosphate, tris(trichloroneopentyl)phosphate, tris(bromodichlorneopentyl)phosphate, tris(chlordibromoneopentyl)phosphate, tris(tribromoneopentyl)phosphate or mixtures thereof.

10. A method or use according to any of claims 1 to 9 further comprising at least one halogenated aromatic compound and/or at least one polyol having 2 or more hydroxyl groups, preferably a polyol having 2 to 12 hydroxyl groups and a molecular weight of 64 to 2000 g/mol, particularly preferably pentaerythritol, dipentaerythritol and tripentaerythritol, particularly di pentaerythritol.

11. Process or use according to claim 10, characterized in that the halogenated aromatic compound is selected from brominated polystyrenes, poly(pentabromobenzyl)acrylates, tris(2,4-dibromophenyl)phosphate, tris(2,4-dichlorophenyl)phosphate, tris(2,4,6-tribromophenyl)phosphate or mixtures thereof.

12. A method or use according to any of claims 1 to 11, characterized in that the polyamide is selected from reinforced or unreinforced PA 6, PA 6.6, PA 4.6, PA 11, PA 12 or mixtures thereof.

13. Process for stabilizing polyamides over a temperature range of less than 150° C. and more than 150° C., characterized in that a polyamide is mixed with a copper compound and a halogen-containing aliphatic phosphate.

14. Use of a composition comprising a copper compound and a halogen-containing aliphatic phosphate for stabilizing polyamides over a temperature range of less than 150° C. and more than 150° C.

15. A method according to claim 13 or use according to claim 14, wherein the copper compound, the halogen-containing aliphatic phosphate and/or the polyamide are as in any of claims 3 to 12.
